(19) United States
(12) Patent Application Publication
(10) Pub. No.: US 2006/0054291 A1
(43) Pub. Date: Mar. 16, 2006

(54) High gloss calcium carbonate coating compositions and coated paper and paper board manufactured from same

(76) Inventors: Amy Christine Dimmick, Bethlehem, PA (US); Kenneth Mueller, Bedminster, NJ (US)

Correspondence Address: Michael J Herman;Minerals Technologies Inc, One Highland Avenue, Bethlehem, PA, 18017, US

(21) Appl. No.: 10/526,343

(22) PCT Filed: Dec. 20, 2001
(86) PCT No.: PCT/US01/49721

§ 371 Date: Mar. 2, 2005

(51) Int. Cl. C09C 1/02; D21H 19/38; B32B 9/00

(52) U.S. Cl. 162/135; 428/402; 106/464; 162/181.2; 162/205

(57) ABSTRACT

A paper coating pigment is provided which includes a blend of a first and a second discrete aragonitic precipitated calcium carbonate (PCC) particles. The first particles of the blended pigment have an average particle size (APS) of about 0.4 microns and the second particles of the blended pigment have an average particle size (APS) of about 0.5 microns. The blended pigment preferably includes a weight ratio of about 50:50 to about 80:20 with a 60:40 weight ratio being most preferred, respectively, of the first 0.4 micron particles to the second 0.5 micron particles. Also provided are a method for preparing coated paper, which includes preparing the blended aragonitic PCC pigment, adding a binder, and applying the pigment to the paper basestock in a slurry containing a binder and or additives. Preferably, blended aragonitic precipitated calcium carbonate pigment is present in an amount of from about 30 weight percent to about 85 weight percent of the mixture with about 70 weight percent to about 15 weight percent balance being clay prior to preparing the slurry.

### FIELD OF THE INVENTION

The present invention relates to mixtures of calcium carbonate particles that are useful in the production of high quality coated papers having high sheet gloss.

### BACKGROUND OF THE INVENTION

In paper manufacture, calcium carbonate, because of its excellent whiteness properties, has been used in coating applications to improve various properties such as the brightness of the paper. Both natural and synthetic calcium carbonates are used in the paper industry. Natural calcium carbonate, or limestone, is ground to a small particle size prior to its use in paper, while synthetic calcium carbonate is manufactured by a precipitation reaction and is called precipitated calcium carbonate (PCC). Precipitated calcium carbonates are generally preferred over ground calcium carbonates in paper production in that the morphology, the size, and the size distribution of the particles, as well as the purity of the as-produced calcium carbonate, can be controlled.

When used as an additive for the paper industry, precipitated calcium carbonates are commonly prepared by the carbonation, with carbon dioxide gas, of an aqueous slurry of calcium hydroxide (“milk of lime”). The precipitated calcium carbonate pigments are then applied to the paper by coating the paper with an aqueous slurry containing the precipitated calcium carbonate and an adhesive.

Calcium carbonate can be precipitated from an aqueous solution in three different crystal forms: the vaterite form which is thermodynamically unstable, the calcite form which is the most stable and the most abundant in nature, and the aragonite form which is metastable under normal ambient conditions of temperature and pressure, but converts to calcite at elevated temperature. The aragonite form has an orthorhombic shape that crystallizes as long, thin needles that may be either aggregated or unaggregated. The calcite form exists in several different shapes of which the most commonly found are the rhombohedral shape having crystals that may be either aggregated or unaggregated and the scalenohedral shape having crystals that are generally unaggregated. All these forms of calcium carbonate can be prepared by carbonation of milk of lime by suitable variation of the process conditions as is known in the art.

Although excellent in respect of the whiteness and absorptivity of printing inks when used as a pigment for paper coating as compared with kaolin clay consisting of platelet particles, conventional calcium carbonate pigments suffer a deficiency in that paper coated using the same is generally poor in sheet gloss. To date, the use of high levels of precipitated calcium carbonate in coating formulations, particularly single-coated applications, has historically resulted in gloss deficiencies compared to kaolin-based formulations. Thus, precipitated calcium carbonate particles have been used as pigments in kaolin-based compositions in lower amounts, i.e., in amounts of 25 weight percent or less.

### RELATED ART

U.S. Pat. No. 5,861,209 teaches aragonitic precipitated calcium carbonate pigments for coating rotogravure printing papers, a method for the preparation of the pigment, a paper coated with the coating pigment, and a method for preparing such a paper. The precipitated calcium carbonate particles have an aspect ratio of from about 3:1 to about 15:1, preferably from about 4:1 to about 7:1, and a multimodal particle size distribution, which is preferably bimodal or trimodal. Preferably, the aragonitic precipitated calcium carbonate is present in an amount from about 20 percent to about 100 percent by weight of the coating pigment. The pigment may also be used with titanium dioxide, talc, calcined clay, satin white, plastic pigments, aluminum trihydrate, mica, or mixtures thereof.

The paper, “In Search of Synergy: Engineering Coatings for Maximum Performance: Optimizing Pigment Blends for Maximum Performance,” by J. Drechsel (1999 Coating Conference, pp. 413-432), teaches the use of fine particle size kaolins and fine ground carbonates in coatings to improve the print gloss of coated papers.

The paper “Structure of the Coating Layer and Optical Properties of Coated Paper,” by L. Jarnstrom et al., Wochenblatt f. Papierfabrikation 17, 736-741, (1996), teaches higher opacity papers and positive synergistic effects achieved when a precipitated calcium carbonate pigment is mixed with a platelike kaolin for coating compositions.

The paper “Optimized Binder Systems for Natural Calcium Carbonate Pigments with Narrow Particle Size Distribution,” by R. Knappich et al., PTS Coating Symposium (1999), pp. 13E to 13E-16, teaches the use of natural ground calcium carbonate pigments with narrow particle size distributions as providing a combination of high brightness, high opacity, and excellent coverage for coated paper and board.

The paper, “Factors Governing Print Performance in Offset Printing of Matt Papers,” by P. G. Drage et al., 1998 TAPPI Coating/Papermakers Conference, pp. 413-433, teaches the production of matt pigments for matt and low gloss papers using bimodal blends of coarse and ultrafine components with GCC being focused on as the coarse fraction.

Japanese Pat. App. No. 10232253 teaches a multilayer coated paper for web rotary offset having dry strength, white paper gloss, multicolor printing gloss and blistering resistance. The multilayer paper includes coating layers having hollow or hemispheric polymer particles.

Japanese Pat. App. No. 10-340790 teaches a coated paper for offset printing having properties of white paper glossiness prepared using an undercoating liquid of a pigment component comprising a wet pulverized needlelike or pillar-shaped precipitated calcium carbonate in an amount of 40 weight percent-100 weight percent of the pigment component.

Japanese Pat. App. No. 11-065703 teaches a coated paper for offset printing having printing glossiness provided by a coating layer mainly of pigment containing a 60 weight percent-90 weight percent fusiform wet ground causticized precipitated calcium carbonate and a copolymer latex having a 50 nm-80 nm average particle diameter and 30 weight percent-50 weight percent gel content as the adhesive.

Japanese Pat. App. No. 11-008162 teaches a matt-coated paper for gravure printing having extremely low white paper glossiness. At least one side of the base paper is coated with a composition having 75 weight percent-85 weight percent agglutinative spindle-shaped precipitated calcium carbonate having average particle diameters of 3.0 μm-5.0 μm in a secondary particle shape and 15 weight percent-25 weight percent of kaolin having average particle diameters of 1.0 μm-2.0 μm.

Japanese Pat. App. No. 11-069426 teaches lightweight-coated paper for offset printing having blank paper glossiness and print glossiness. The paper has two coated layers both continuing a pigment and an adhesive, the top coat layer having 50 parts by weight-85 parts by weight of calcium carbonate having an average particle diameter not smaller than 0.2 μm and smaller than 0.5 μm as the pigment and 8 parts by weight-15 parts by weight copolymer latex having 50 nm-70 nm average particle diameter and 50 percent-70 percent gel content as the adhesive both based on 100 parts by weight pigment.

Thus, there still remains a need for improved coating grade calcium carbonate pigments for producing high sheet gloss papers.

### SUMMARY OF THE INVENTION

The present invention relates to a paper coating pigment which comprises a blend of first and second discrete aragonitic precipitated calcium carbonate (PCC) particles. The first particle of the blended pigment has an average particle size (APS) of about 0.4 microns and the second particle of the blended pigment has an average particle size (APS) of about 0.5 microns. The pigment preferably comprises about a 50:50 to about a 80:20 weight ratio of the first 0.4 micron particle to the second 0.5 micron particle, with about a 60:40 weight ratio being most preferred.

The present invention also relates to a method for preparing the coated paper, which comprises preparing the blended aragonitic precipitated calcium carbonate pigment, adding a clay, and applying the pigment to the paper basestock in a slurry containing a binder and other additives. Preferably, the blended aragonitic precipitated calcium carbonate is present in an amount of from about 30 weight percent to about 85 weight percent of the mixture with the about 70 weight percent to about 15 weight percent balance being clay prior to preparing the slurry.

### DETAILED DESCRIPTION OF THE INVENTION

Unless otherwise specified, all reference to parts or percent herein refer to percent by weight.

The present invention is related to a paper coating composition containing a blend of calcium carbonate particles, a method of using the composition to improve sheet gloss, and a process of producing a paper having high sheet gloss and the paper made from the process. The calcium carbonate is preferably a precipitated aragonite (i.e., orthorhombic crystalline form). When used in pigment formulations, the calcium carbonate pigment blend of the present invention provides improvement in the sheet gloss, when compared to typical prior art coating grade carbonates, and is particularly advantageous in the production of high-gloss papers including paper board.

The improvement in sheet gloss of coated papers using the blended pigment is unexpected and is attributed to a synergy created by using particles having particle size distributions with mean values that are from about 0.1 microns to about 0.2 microns in difference in the blended pigment. In addition, the calcium carbonate pigment of the present invention has other clear advantages over other calcium carbonate pigments including its ease of calendering a paper sheet and the resultant sheet gloss and print gloss of coated papers using the pigment blend.

The calcium carbonate component particles useful in the blended calcium carbonate pigment blend of the invention are preferably synthesized (i.e., precipitated) by the carbonation with carbon dioxide gas of an aqueous slurry of calcium hydroxide (“milk of lime”) to produce discrete aragonitic particles. In a preferred embodiment, preparation of the blended calcium carbonates of the invention is accomplished by mixing component particles having mean particle sizes of 0.40 microns and 0.50 microns, which are commercially available from Minerals Technologies Inc., New York, N.Y., as OPACARB® A40 PCC and OPACARB® A50 PCC, respectively.

More specifically, OPACARB®A40 PCC and OPACARB®A50 PCC are aragonitic precipitated calcium carbonate particles with average particle sizes of about 0.4 microns and 0.5 microns, respectively, having narrow particle size distributions of ±0.02 microns about the mean.

The average particle size of the particles, according to the present invention, were determined by using a Micromeritics Sedigraph 5100 Analyzer, an instrument for measuring particle size distributions using Stokes law (see CRC Handbook of Chemistry and Physics, 69^{th} Edition 1988-1989, page F-105), which gives the rate of fall of a small sphere in a viscous fluid. From this, particle size distributions on a mass (weight) basis and average particle size are determined.

Improved coating results are obtained with the aragonitic PCC pigment of the present invention, either alone or in blends with any other conventional coating pigment. The PCC content of the pigment when mixed with clay can range from about 30 weight percent to about 85 weight percent of the coating formulation, with 60 weight percent being preferred. The pigment mixture of the present invention is particularly advantageous for use in high-gloss printing papers, and may be mixed with one or more conventional binders, thickeners and/or lubricants as is known in the art. The coating can also contain dilution water in an amount needed to bring the final solids content of the coatings to a range of from about 50 weight percent to about 70 weight percent.

Embodiments of the present invention will now be described by way of example only with reference to the following Examples. The following non-limiting examples are merely illustrative of the present invention, and are not to be construed as limiting the invention, the scope of which is defined by the appended claims.

In each experimental formulation, 40 total parts of the precipitated calcium carbonate pigment was used and mixed with a coating grade clay having 72 percent solids using a conventional flat-blade Cowles-type mixer. The clay used for all examples below was ALPHAGLOSS® clay available from Huber Corporation. OPACARB®40 PCC; OPACARB®A50 PCC; and ALBAGLOS®S PCC particles were provided alone and in combination to evaluate the effect of various calcium carbonate particles.

Specifically, Coating Mixture Nos. 1 and 7 were provided to evaluate the effect of OPACARB®A40 PCC aragonitic particles and OPACARB®A50 PCC aragonitic particles, respectively, when used alone with ALPHAGLOSS® clay. Coating Mixture Nos. 2, 3, and 4 were provided to evaluate the effect of OPACARB®A40 PCC aragonitic particles when used in varying weight ratios ranging from about 40:60 to about 60:40 with ALBAGLOS® S PCC calcite particles traditionally used with clay-based paper coating compositions. Coating Mixture Nos. 6 and 5 were provided to evaluate blended aragonitic PCC pigments having OPACARB® A40 PCC aragonitic particles and OPACARB®A50 PCC aragonitic particles in weight ratios according to the present invention.

The compositions of the coating mixtures prepared are shown in Table 1 below with the amounts of the calcium carbonate particles and clay being present following weight percentages.

TABLE 1

| PIGMENT | | | | | | | |
|---|---|---|---|---|---|---|---|
| MIXTURE# | 1 | 2 | 3 | 4 | 5* | 6* | 7 |
| ALBAGLOS ® S | | 25 | 20 | 15 | | | |
| PCC (wt. Percent) | | | | | | | |
| OPACARB ® A40 | 40 | 15 | 20 | 25 | 25 | 20 | |
| PCC (wt. Percent) | | | | | | | |
| OPACARB ® A50 | | | | | 15 | 20 | 40 |
| PCC (wt. Percent) | | | | | | | |
| ALPHAGLOSS ® | 60 | 60 | 60 | 60 | 60 | 60 | 60 |
| CLAY (wt. Percent) | | | | | | | |

*Calcium carbonate pigment according to the present invention.

After mixing the coating formulations above, binder was added to each and mixed again using a conventional flat-blade Cowles-type mixer. Each calcium carbonate pigment formulation contained the same binder containing 11 parts GENFLO® 5905 styrene/butadiene latex available from Gencorp Corporation (now Omnova Corporation), 3 parts hydroxyethylated starch available from Penford Starch Corporation as PENFORD® 280 Gum, and 1 part calcium stearate lubricant. A standard paper thickener available from Hercules Corporation as ADMIRAL® 3089 was added to each coating sample to achieve a target Brookfield 100 revolutions per minute (rpm) viscosity of 1200 centipoise (cps). Generally, the amount of thickener used to achieve the target viscosities increased as the carbonate level increased.

Pigment coatings were formulated at approximately 60 percent solids, and tested for percent solids and water retention character as determined by the AA-GWR method (Kaltec Scientific, USA). Low shear viscosities in centipoise were measured at 10 rpm, 20 rpm, 50 rpm and 100 rpm using a Brookfield model RVT viscometer. High shear viscosity measurements were made using a Hercules high shear viscometer from Kaltec Scientific, USA. The Hercules viscosities were run using the following conditions: E bob, 400,000 dyne−cm/cm spring constant, 0 rpm-4400 rpm, room temperature. The formulation data for the coatings tested are provided in Table 2.

TABLE 2

| COATING# | 1 | 2 | 3 | 4 | 5* | 6* | 7 |
|---|---|---|---|---|---|---|---|
| SOLIDS, percent | 60.4 | 60.2 | 60.5 | 60.3 | 60.2 | 60.1 | 60.2 |
| AA-GWR, grams | 89 | 90 | 84 | 91 | 94 | 88 | 97 |
| per square meter | | | | | | | |
| (gsm) | | | | | | | |
| HERCULES | 50.0 | 47.9 | 46.5 | 42.5 | 45.1 | 41.0 | 38.9 |
| VISCOSITY, | | | | | | | |
| cps @ 4400 rpm | | | | | | | |
| BROOKFIELD | | | | | | | |
| VISCOSITY | | | | | | | |
| cps @ 100 rpm | 1420 | 1100 | 1200 | 1060 | 1310 | 1310 | 1120 |
| cps @ 50 rpm | 2560 | 1800 | 1940 | 1720 | 2090 | 2240 | 1840 |
| cps @ 20 rpm | 5250 | 3650 | 3900 | 3500 | 4275 | 4700 | 3800 |
| cps @ 10 rpm | 9600 | 6600 | 7000 | 6400 | 7600 | 8600 | 7000 |
| pH (adjusted to 8.5- | 8.5 | 8.5 | 8.5 | 8.5 | 8.5 | 8.5 | 8.5 |
| 8.9 with NaOH) | | | | | | | |
| Addition Thickener | 27 | 30 | 30 | 30 | 25 | 30 | 25 |

*Aragonitic precipitated calcium carbonate pigment according to the present invention.

After preparation, the coatings were applied to a 51.1 pounds per ream (70 grams per square meter) paper basestock using a Cylindrical Laboratory Coater (CLC-6000). The coat weight target was 9 pounds per 3300 square feet. The coated papers were then calendered at 150 degrees Fahrenheit on a laboratory supercalender having two sets of rollers with nips providing 800 pounds per square inch (psi).

Standard testing of the coated sheets included paper sheet gloss, print gloss, brightness and opacity. The coated sheet test data are given in Table 3, with the print gloss values being determined using the Nancy Plowman Test Method (NPA) and all remaining data being determined using standard TAPPI test methods, which test methods will be readily recognized by those skilled in the art.

TABLE 3

| COATING# | 1 | 2 | 3 | 4 | 5* | 6* | 7 |
|---|---|---|---|---|---|---|---|
| SHEET GLOSS, | 73.6 | 72.6 | 72.1 | 72.7 | 75.7 | 74.6 | 73.3 |
| percent | | | | | | | |
| NPA PRINT | 90.6 | 92.8 | 92.1 | 91.2 | 91.8 | 91.6 | 92.4 |
| GLOSS, percent | | | | | | | |
| Rapida SFO Black | | | | | | | |
| BRIGHTNESS | 86.0 | 85.7 | 86.0 | 85.8 | 86.0 | 85.9 | 85.9 |
| TAPPI, percent | | | | | | | |
| OPACITY | 89.6 | 90.2 | 89.7 | 89.9 | 90.1 | 90.0 | 90.0 |
| TAPPI, percent | | | | | | | |
| COLOR | | | | | | | |
| HUNTER L | 92.4 | 92.4 | 92.4 | 92.4 | 92.5 | 92.4 | 92.4 |
| HUNTER A | 0.0 | 0.0 | 0.0 | 0.0 | −0.1 | −0.1 | −0.1 |
| HUNTER B | 2.3 | 2.3 | 2.3 | 2.3 | 2.4 | 2.4 | 2.4 |
| Gurley Porosity | 83 | 93 | 86 | 91 | 94 | 91 | 95 |
| (Sec @ 10 cc) | | | | | | | |
| PPS-10 Roughness | 1.32 | 1.41 | 1.45 | 1.36 | 1.34 | 1.37 | 1.42 |
| IGT Pick, | 91 | 91 | 91 | 76 | 82 | 82 | 76 |
| (cm @ 3.0 m/s) | | | | | | | |
| SOLIDS, percent | 60.4 | 60.2 | 60.5 | 60.3 | 60.2 | 60.1 | 60.2 |

*Calcium carbonate pigment according to the present invention.

These data demonstrate the improved sheet gloss that is provided by the coating pigment of the present invention and also demonstrates that the calcium carbonate coating pigment can also be used in combination with clay in high quantities without degrading print gloss properties. When comparing the sheet gloss of Coating Nos. 6 and 5, a marked improvement is seen when using blended calcium carbonate pigments according to the present invention having OPACARB®A40 PCC aragonitic particles and OPACARB®A50 PCC aragonitic particles in weight ratios of from about 50:50 to about 80:20, and, preferably, about 60:40.

Moreover, these particle mixtures provide for improved sheet gloss without the attendant decrease in print gloss normally associated with the use of higher carbonate contents.

Specifically, the sheet and print gloss ranges of 74.6 percent-75.7 percent and 91.6 percent Rapida SFO Black-91.8 percent Rapida SFO Black achieved using OPACARB®A40 PCC particles and OPACARB®A50 PCC particles in weight ratios according to the present invention are higher than the respective sheet and print glosses achieved when using OPACARB®A40 PCC alone in Coating No. 1 (73.6 percent, 90.6 percent Rapida SFO Black) and is higher than the sheet gloss and comparable to the print gloss achieved when using OPACARB®A50 PCC alone in Coating No. 7 (73.3 percent, 92.4 percent Rapida SFO Black). Moreover, a synergistic effect is observed upon using higher ratios of OPACARB®A40 PCC to OPACARB®A50 PCC which is contrary to the much lower print gloss (90.6 percent Rapida SFO Black) achieved when using OPACARB®A40 PCC alone with clay (Coating No. 1) and the print gloss (92.4 percent Rapida SFO Black) achieved when using OPACARB®A50 PCC alone with clay (Coating No. 7).

In comparing the use of the aragonitic blended pigment of the present invention with aragonite mixtures containing calcite particles, improved sheet glosses are also observed. Specifically, when using OPACARB®A40 PCC particles and OPACARB®A50 PCC particles in weight ratios according to the present invention (Coating Nos. 6 and 5), sheet gloss values ranging 74.6 percent-75.7 percent were markedly improved over the sheet gloss values of 72.1 percent-72.7 percent obtained using OPACARB®A40 PCC aragonitic particles in weight ratios ranging from 40:60 to 60:40 with ALBAGLOS® S PCC calcite particles (Coating Nos. 2-4). Moreover, this marked improvement in sheet gloss for the blended aragonitic pigment was obtained with comparable print gloss properties to those containing the aragonite/calcite pigment mix.

It will be observed that the particles utilized in the blends according to the present invention exhibit particle size distributions with mean values that are from about 0.1 microns to about 0.2 microns in difference. It is envisioned that other blends having similar particle size distribution differences would exhibit similar synergistic effects on coated sheet properties. Moreover, it is expected that in addition to the aragonite/aragonite blends, other like-kind mixtures of calcium carbonate morphologies (eg., calcite/calcite) meeting the above particle size distribution criteria would exhibit similar synergistic effects on coated sheet properties.

While embodiments and applications of this invention have been shown and described, it will be appreciated by those skilled in the art that modifications and embodiments are possible without departing from the inventive concepts herein described. Therefore, it is intended that the appended claims cover all such modifications and embodiments that fall within the true spirit and scope of the present invention. What is claimed is:

1. A calcium carbonate product for use in coating compositions to provide a surface finish having high sheet gloss, the product comprising:
first calcium carbonate particles having a first particle size distribution having a first mean, and
second calcium carbonate particles having a second particle size distribution having a second mean, the first and second means having a difference of about 0.1 microns to about 0.2 microns,
the first calcium carbonate particles and the second calcium carbonate particles being provided respectively in a weight ratio from about 50:50 to about 80:20.

2. The calcium carbonate product according to claim 1, wherein the weight ratio of the first calcium carbonate particles to the second calcium carbonate particles is about 60:40.

3. The calcium carbonate product according to claim 1, wherein the first calcium carbonate particles and the second calcium carbonate particles are aragonitic precipitated calcium carbonate (PCC) particles.

4. The calcium carbonate product according to claim 1, wherein the first calcium carbonate particles have an average particle size (APS) of about 0.4 microns and the second calcium carbonate particles have an average particle size (APS) of about 0.5 microns.

5. The calcium carbonate product according to claim 2, wherein the first calcium carbonate particles have an average particle size (APS) of about 0.4 microns and the second calcium carbonate particles have an average particle size (APS) of about 0.5 microns.

6. The calcium carbonate product according to claim 4, wherein the first calcium carbonate particles have an average particle size (APS) of about 0.4 microns and the second calcium carbonate particles have an average particle size (APS) of about 0.5 microns.

7. A paper coating pigment comprising:
first calcium carbonate particles having a first particle size distribution having a first mean, and
second calcium carbonate particles having a second particle size distribution having a second mean, the first and second means having a difference of about 0.1 microns to about 0.2 microns
the first calcium carbonate pigment and the second calcium carbonate pigment being provided respectively in a weight ratio from about 50:50 to about 80:20.

8. The paper coating pigment according to claim 7, wherein the weight ratio of the first calcium carbonate pigment to the second calcium carbonate pigment are provided is about 60:40.

9. The paper coating pigment according to claim 7, wherein the first calcium carbonate pigment and the second calcium carbonate pigment are aragonitic precipitated calcium carbonate (PCC) pigments.

10. The paper coating pigment according to claim 7, wherein the first calcium carbonate particles have an average particle size (APS) of about 0.4 microns and the second calcium carbonate particles have an average particle size (APS) of about 0.5 microns.

11. The paper coating pigment according to claim 8, wherein the first calcium carbonate particles have an average particle size (APS) of about 0.4 microns and the second calcium carbonate particles have an average particle size (APS) of about 0.5 microns.

12. The paper coating pigment according to claim 9, wherein the first calcium carbonate particles have an average particle size (APS) of about 0.4 microns and the second calcium carbonate particles have an average particle size (APS) of about 0.5 microns.

13. A process for producing a paper having high sheet gloss, comprising steps of:
a) providing first calcium carbonate particles having a first particle size distribution having a first mean, and
b) providing second calcium carbonate particles having a second particle size distribution having a second mean, the first and second means having a difference of about 0.1 microns to about 0.2 microns,
c) mixing the first calcium carbonate particles and the second calcium carbonate particles respectively in a weight ratio from about 50:50 to about 80:20 to form a pigment blend,
d) mixing the pigment blend mixture with at least one binder to form a coating slurry,
e) coating a paper with the coating slurry to form a coating, and
f) drying and calendering the paper to form a coated paper having high sheet gloss.

14. The process according to claim 13, wherein the weight ratio of the first calcium carbonate particles to the second calcium carbonate particles is about 60:40.

15. The process according to claim 13, wherein the first calcium carbonate particles and the second calcium carbonate particles are aragonitic precipitated calcium carbonate (PCC) particles.

16. The process according to claim 13, further comprising steps of providing a clay and mixing the clay with the coating mixture in step c) in an amount ranging from about 15 weight percent to about 70 weight percent.

17. The paper coating pigment according to claim 13, wherein the first calcium carbonate particles have an average particle size (APS) of about 0.4 microns and the second calcium carbonate particles have an average particle size (APS) of about 0.5 microns.

18. The paper coating pigment according to claim 14, wherein the first calcium carbonate particles have an average particle size (APS) of about 0.4 microns and the second calcium carbonate particles have an average particle size (APS) of about 0.5 microns.

19. The paper coating pigment according to claim 15, wherein the first calcium carbonate particles have an average particle size (APS) of about 0.4 microns and the second calcium carbonate particles have an average particle size (APS) of about 0.5 microns.

20. The paper coating pigment according to claim 16, wherein the first calcium carbonate particles have an average particle size (APS) of about 0.4 microns and the second calcium carbonate particles have an average particle size (APS) of about 0.5 microns.

21. The paper product produced-by-the-process according to claim 13.

22. A method of improving sheet gloss of a paper product comprising a step of incorporating composition of claim 1 to a slurry for coating a base paper.

23. A method of improving sheet gloss of a paper product comprising a step of incorporating composition of claim 5 to a slurry for coating a base paper.

24. A method of improving sheet gloss of a paper product comprising a step of incorporating composition of claim 9 to a slurry for coating a base paper.
